(19) United States
(12) Patent Application Publication
(10) Pub. No.: US 2021/0004216 A1
(43) Pub. Date: Jan. 7, 2021

(54) AUTOMOTIVE ELECTRONIC DEVICE AND PROCESSING METHOD FOR ABNORMAL OPERATION OF AUTOMOTIVE ELECTRONIC DEVICE

(71) Applicant: QISDA CORPORATION, Taoyuan City (TW)

(72) Inventor: Chih-Ming Chang, Taoyuan City (TW)

(21) Appl. No.: 16/591,641

(22) Filed: Oct. 3, 2019

(30) Foreign Application Priority Data
Jul. 3, 2019 (CN) 201910597000.7

(51) Int. Cl. G06F 8/61; H04L 29/08; G06F 1/26; G06F 8/65; G07C 5/08

(52) U.S. Cl. CPC G06F 8/61; H04L 67/34; G07C 5/0808; G06F 1/26; G06F 8/65; H04L 67/125

(57) ABSTRACT

An automotive electronic device includes a first processing module, a second processing module, a logic control unit and a power supply unit. The second processing module is coupled to the first processing module. The logic control unit is coupled to the first processing module and the second processing module. The power supply unit is coupled to the first processing module, the second processing module and the logic control unit. When the automotive electronic device is powered on, the power supply unit supplies power to the first processing module, the second processing module and the logic control unit. When the second processing module determines that the first processing module is operating abnormally, the second processing module controls the power supply unit to continuously supply power to the first processing module through the logic control unit and installs a first software to the first processing module.

### BACKGROUND OF THE INVENTION

### 1. Field of the Invention

The invention relates to an automotive electronic device and, more particularly, to an automotive electronic device capable of automatically reinstalling a software when an abnormal operation occurs and a processing method for the abnormal operation of the automotive electronic device.

### 2. Description of the Prior Art

A telematics control unit (TCU) is a device capable of providing global positioning system (GPS) service and network communication for a vehicle. The telematics control unit allows an external system to interact with an electronic component in the vehicle, so as to provide additional service or function. At present, the telematics control unit cannot automatically reinstall an operating system (OS) or other necessary software when an abnormal operation occurs (e.g. the telematics control unit cannot be powered on, a software cannot be updated, and so on). Accordingly, a user can only send the telematics control unit to an original manufacturer for repair and that wastes time.

### SUMMARY OF THE INVENTION

An objective of the invention is to provide an automotive electronic device capable of automatically reinstalling a software when an abnormal operation occurs and a processing method for the abnormal operation of the automotive electronic device, so as to solve the aforesaid problems.

According to an embodiment of the invention, an automotive electronic device comprises a first processing module, a second processing module, a logic control unit and a power supply unit. The second processing module is coupled to the first processing module. The logic control unit is coupled to the first processing module and the second processing module. The power supply unit is coupled to the first processing module, the second processing module and the logic control unit. When the automotive electronic device is powered on, the power supply unit supplies power to the first processing module, the second processing module and the logic control unit. When the second processing module determines that the first processing module is operating abnormally, the second processing module controls the power supply unit to continuously supply power to the first processing module through the logic control unit and installs a first software to the first processing module.

According to another embodiment of the invention, a processing method for an abnormal operation of an automotive electronic device comprising steps of when the automotive electronic device is powered on, a power supply unit supplies power to a first processing module, a second processing module and a logic control unit; when the second processing module determines that the first processing module is operating abnormally, the second processing module controls the power supply unit to continuously supply power to the first processing module through the logic control unit; and the second processing module installs a first software to the first processing module.

As mentioned in the above, when the first processing module of the automotive electronic device is operating abnormally (e.g. the first processing module cannot be powered on, a software cannot be updated, and so on), the second processing module of the automotive electronic device controls the power supply unit to continuously supply power to the first processing module through the logic control unit, such that the first processing module can still keep operating. Then, the second processing module installs a software (e.g. operating system or other necessary software), which is stored in the second processing module in advance or downloaded from an external device, to the first processing module, so as to try to recover the first processing module from abnormal operation. Once the first processing module can operate normally after the software is installed, a user does not need to send the automotive electronic device to an original manufacturer for repair, such that time is saved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating an automotive electronic device according to an embodiment of the invention.

FIG. 2 is a flowchart illustrating a processing method for an abnormal operation of an automotive electronic device according to an embodiment of the invention.

FIG. 3 is a functional block diagram illustrating an automotive electronic device according to another embodiment of the invention.

FIG. 4 is a flowchart illustrating a processing method for an abnormal operation of an automotive electronic device according to another embodiment of the invention.

### DETAILED DESCRIPTION

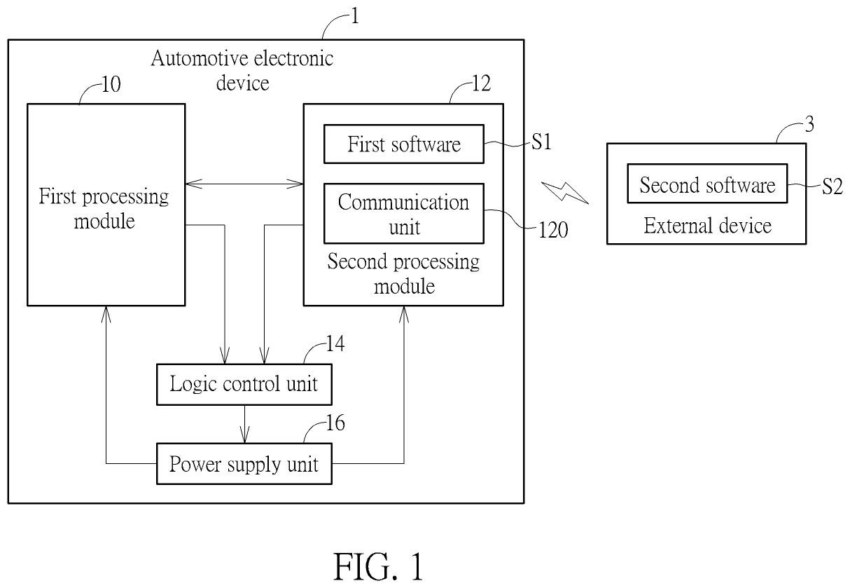

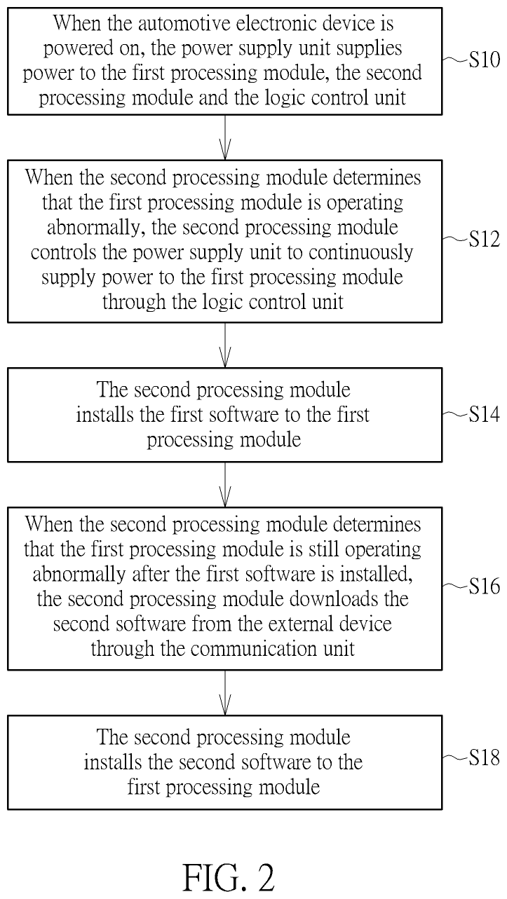

Referring to FIGS. 1 and 2, FIG. 1 is a functional block diagram illustrating an automotive electronic device 1 according to an embodiment of the invention and FIG. 2 is a flowchart illustrating a processing method for an abnormal operation of an automotive electronic device according to an embodiment of the invention. The processing method shown in FIG. 2 is adapted to the automotive electronic device 1 shown in FIG. 1.

As shown in FIG. 1, the automotive electronic device 1 comprises a first processing module 10, a second processing module 12, a logic control unit 14 and a power supply unit 16, wherein the second processing module 12 is coupled to the first processing module 10, the logic control unit 14 is coupled to the first processing module 10 and the second processing module 12, and the power supply unit 16 is coupled to the first processing module 10, the second processing module 12 and the logic control unit 14. In this embodiment, the automotive electronic device 1 may be, but not limited to, a telematics control unit (TCU), wherein the first processing module 10 may be, but not limited to, a microcontroller unit (MCU) and the second processing module 12 may be, but not limited to, a network access device (NAD). In another embodiment, the first processing module 10 may also be the network access device and the second processing module 12 may also be the microcontroller unit according to practical applications. Furthermore, the logic control unit 14 may be a logic control circuit and the power supply unit 16 may be a battery or other power supply modules.

In this embodiment, a first software S1 is stored in the second processing module 12 in advance. Still further, the second processing module 12 may comprise a communication unit 120, such that the second processing module 12 may communicate with an external device 3 through the communication unit 120. The external device 3 may be a server or other electronic devices provided by a service provider of the automotive electronic device 1 and used to provide a second software S2. According to practical applications, the first software S1 and the second software S2 may be operating systems or other necessary software allowing the first processing module to operate normally. Moreover, the communication unit 120 may be a wireless communication module (e.g. WiFi module or other wireless modules) or a wired communication interface (e.g. universal serial bus (USB) port or other ports), such that the second processing module 12 may communicate with the external device 3 by a wireless or wired manner.

When the automotive electronic device 1 is powered on, the power supply unit 16 supplies power to the first processing module 10, the second processing module 12 and the logic control unit 14 (step S10 in FIG. 2). Needless to say, the power supply unit 16 also supplies power to other electronic components in the automotive electronic device 1. In general, after the automotive electronic device 1 powered on, the first processing module 10 and the second processing module 12 will transmit communication signals to each other continuously, so as to maintain normal operation. Accordingly, when the second processing module 12 does not receive a communication signal from the first processing module 10 within a predetermined time period (e.g. 30 seconds, 1 minute, etc.), the second processing module 12 may determine that the first processing module 10 is operating abnormally. When the second processing module 12 determines that the first processing module 10 is operating abnormally, the second processing module 12 may control the power supply unit 14 to continuously supply power to the first processing module 10 through the logic control unit 14 (step S12 in FIG. 2), such that the first processing module 10 can still keep operating. Then, the second processing module 12 installs the first software S1 to the first processing module 10 (step S14 in FIG. 2), so as to try to recover the first processing module 10 from abnormal operation. Once the first processing module 10 can operate normally after the first software S1 is installed (i.e. after the first processing module 10 installs the first software S1, the second processing module 12 receives the communication signal from the first processing module 10 within the predetermined time period), a user does not need to send the automotive electronic device 1 to an original manufacturer for repair, such that time is saved.

On the other hand, when the second processing module 12 determines that the first processing module 10 is still operating abnormally after the first software S1 is installed (i.e. after the first processing module 10 installs the first software S1, the second processing module 12 still does not receive the communication signal from the first processing module 10 within the predetermined time period), the second processing module 12 may further download the second software S2 from the external device 3 through the communication unit 120 (step S16 in FIG. 2). Then, the second processing module 12 installs the second software S2 to the first processing module 10 (step S18 in FIG. 2), so as to try to recover the first processing module 10 from abnormal operation. Once the first processing module 10 can operate normally after the second software S2 is installed, the user does not need to send the automotive electronic device 1 to the original manufacturer for repair, such that time is saved.

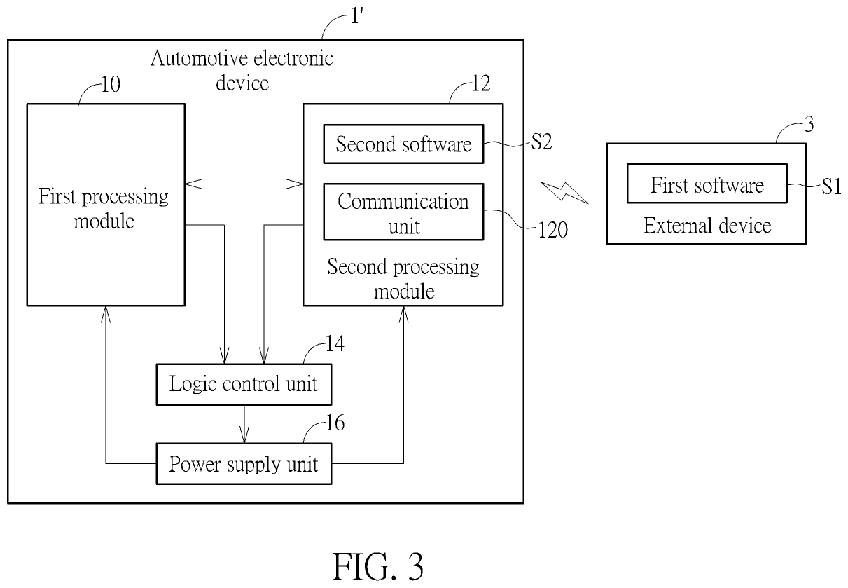

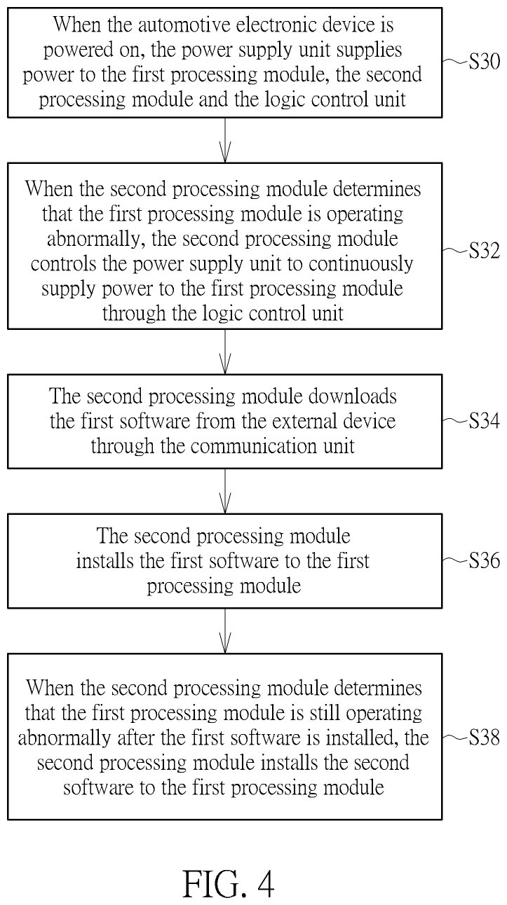

Referring to FIGS. 3 and 4, FIG. 3 is a functional block diagram illustrating an automotive electronic device 1′ according to another embodiment of the invention and FIG. 4 is a flowchart illustrating a processing method for an abnormal operation of an automotive electronic device according to another embodiment of the invention. The processing method shown in FIG. 4 is adapted to the automotive electronic device 1′ shown in FIG. 3. The main difference between the automotive electronic device 1′ and the aforesaid automotive electronic device 1 is that the second software S2 of the automotive electronic device 1′ is stored in the second processing module 12 in advance. Furthermore, the external device 3 is used to provide the first software S1. It should be noted that the same elements in FIG. 3 and FIG. 1 are represented by the same numerals, so the repeated explanation will not be depicted herein again.

When the automotive electronic device 1′ is powered on, the power supply unit 16 supplies power to the first processing module 10, the second processing module 12 and the logic control unit 14 (step S30 in FIG. 4). Needless to say, the power supply unit 16 also supplies power to other electronic components in the automotive electronic device 1′. In general, when the first processing module 10 executes a software updating process, the first processing module 10 will transmit a software updating signal to notice the second processing module 12. After the software updating process is completed, the first processing module 10 will transmit an update completed signal to notice the second processing module 12. Accordingly, when the first processing module 10 executes a software updating process and the second processing module 12 does not receive an update completed signal from the first processing module 10 within a predetermined time period (e.g. 3 minutes, 5 minutes, etc.), the second processing module 12 may determine that the first processing module 10 is operating abnormally. When the second processing module 12 determines that the first processing module 10 is operating abnormally, the second processing module 12 may control the power supply unit 14 to continuously supply power to the first processing module 10 through the logic control unit 14 (step S32 in FIG. 4), such that the first processing module 10 can still keep operating. Then, the second processing module 12 may download the first software S1 from the external device 3 through the communication unit 120 (step S34 in FIG. 4). Then, the second processing module 12 installs the first software S1 to the first processing module 10 (step S36 in FIG. 4), so as to try to recover the first processing module 10 from abnormal operation. Once the first processing module 10 can operate normally after the first software S1 is installed (i.e. after the first processing module 10 installs the first software S1, the second processing module 12 receives the update completed signal or the communication signal from the first processing module 10 within the predetermined time period), a user does not need to send the automotive electronic device 1′ to an original manufacturer for repair, such that time is saved.

On the other hand, when the second processing module 12 determines that the first processing module 10 is still operating abnormally after the first software S1 is installed (i.e. after the first processing module 10 installs the first software S1, the second processing module 12 still does not receive the update completed signal or the communication signal from the first processing module 10 within the predetermined time period), the second processing module 12 may further install the second software S2 to the first processing module 10 (step S38 in FIG. 4), so as to try to recover the first processing module 10 from abnormal operation. Once the first processing module 10 can operate normally after the second software S2 is installed, the user does not need to send the automotive electronic device 1′ to the original manufacturer for repair, such that time is saved.

As mentioned in the above, when the first processing module of the automotive electronic device is operating abnormally (e.g. the first processing module cannot be powered on, a software cannot be updated, and so on), the second processing module of the automotive electronic device controls the power supply unit to continuously supply power to the first processing module through the logic control unit, such that the first processing module can still keep operating. Then, the second processing module installs a software (e.g. operating system or other necessary software), which is stored in the second processing module in advance or downloaded from an external device, to the first processing module, so as to try to recover the first processing module from abnormal operation. Once the first processing module can operate normally after the software is installed, a user does not need to send the automotive electronic device to an original manufacturer for repair, such that time is saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automotive electronic device comprising
a first processing module;
a second processing module coupled to the first processing module;
a logic control unit coupled to the first processing module and the second processing module; and
a power supply unit coupled to the first processing module, the second processing module and the logic control unit;
wherein when the automotive electronic device is powered on, the power supply unit supplies power to the first processing module, the second processing module and the logic control unit; when the second processing module determines that the first processing module is operating abnormally, the second processing module controls the power supply unit to continuously supply power to the first processing module through the logic control unit and installs a first software to the first processing module.

2. The automotive electronic device of claim 1, wherein when the second processing module does not receive a communication signal from the first processing module within a predetermined time period, the second processing module determines that the first processing module is operating abnormally.

3. The automotive electronic device of claim 2, wherein the first software is stored in the second processing module in advance.

4. The automotive electronic device of claim 3, wherein the second processing module comprises a communication unit, the second processing module communicates with an external device through the communication unit, and the external device provides a second software; when the second processing module determines that the first processing module is still operating abnormally after the first software is installed, the second processing module downloads the second software from the external device through the communication unit and installs the second software to the first processing module.

5. The automotive electronic device of claim 1, wherein when the first processing module executes a software updating process and the second processing module does not receive an update completed signal from the first processing module within a predetermined time period, the second processing module determines that the first processing module is operating abnormally.

6. The automotive electronic device of claim 5, wherein the second processing module comprises a communication unit, the second processing module communicates with an external device through the communication unit, and the external device provides the first software; when the second processing module determines that the first processing module is operating abnormally, the second processing module downloads the first software from the external device through the communication unit.

7. The automotive electronic device of claim 6, wherein a second software is stored in the second processing module in advance; when the second processing module determines that the first processing module is still operating abnormally after the first software is installed, the second processing module installs the second software to the first processing module.

8. A processing method for an abnormal operation of an automotive electronic device, the automotive electronic device comprising a first processing module, a second processing module, a logic control unit and a power supply unit, the processing method comprising steps of:
when the automotive electronic device is powered on, the power supply unit supplies power to the first processing module, the second processing module and the logic control unit;
when the second processing module determines that the first processing module is operating abnormally, the second processing module controls the power supply unit to continuously supply power to the first processing module through the logic control unit; and
the second processing module installs a first software to the first processing module.

9. The processing method of claim 8, wherein when the second processing module does not receive a communication signal from the first processing module within a predetermined time period, the second processing module determines that the first processing module is operating abnormally.

10. The processing method of claim 9, wherein the first software is stored in the second processing module in advance.

11. The processing method of claim 10, wherein the second processing module comprises a communication unit, the second processing module communicates with an external device through the communication unit, the external device provides a second software, the processing method further comprises steps of:
when the second processing module determines that the first processing module is still operating abnormally after the first software is installed, the second processing module downloads the second software from the external device through the communication unit; and
the second processing module installs the second software to the first processing module.

12. The processing method of claim 8, wherein when the first processing module executes a software updating process and the second processing module does not receive an update completed signal from the first processing module within a predetermined time period, the second processing module determines that the first processing module is operating abnormally.

13. The processing method of claim 12, wherein the second processing module comprises a communication unit, the second processing module communicates with an external device through the communication unit, the external device provides the first software, the processing method further comprises step of:
when the second processing module determines that the first processing module is operating abnormally, the second processing module downloads the first software from the external device through the communication unit.

14. The processing method of claim 13, wherein a second software is stored in the second processing module in advance, the processing method further comprises step of:
when the second processing module determines that the first processing module is still operating abnormally after the first software is installed, the second processing module installs the second software to the first processing module.
